(19) United States
(12) Patent Application Publication
(10) Pub. No.: US 2010/0217665 A1
(43) Pub. Date: Aug. 26, 2010

(54) METHOD AND SYSTEM FOR LAUNCHING AN ADVERTISING CAMPAIGN

(76) Inventor: Vishal Naresh Sharma, Kondwa Pune (IN)

Correspondence Address: DAVID A. GUERRA;INTERNATIONAL PATENT GROUP, LLC, Suite 700, 1816 Crowchild Trail N.W., CALGARY, AB, T2M 3Y7, CA

(21) Appl. No.: 12/484,358

(22) Filed: Jun. 15, 2009

(30) Foreign Application Priority Data
Feb. 25, 2009 (IN) 403/CHE/2009

(51) Int. Cl. G06Q 30/00

(52) U.S. Cl. 705/14.45; 705/14.72; 705/14.55; 705/14.66; 705/14.67; 705/14.52; 705/14.48; 705/14.54

(57) ABSTRACT

Systems and methods directed to online media advertising are provided. Through the use of the present invention, one may more effectively use competitive analysis, build a media plan, generate a creative piece from the scratch for an advertising campaign, purchase media across multiple publishers and track the campaign through a single web-based platform. The system being a computer system having a memory, a processor, input/output devices, a system bus operatively coupling the computer system components, a plan module adapted to receive one or more user-defined campaign criteria from a user and prepare a media plan satisfying the user-defined campaign criteria, and a purchase module adapted to receive one or more inputs from the user and automatically create one or more media booking orders based on the inputs.

### CROSS-REFERENCE TO RELATED APPLICATION

This application claims the benefit of priority under 35 U.S.C 119 to co-pending India Patent Application No. 403/CHE/2009 filed on Feb. 25, 2009. The entire disclosure of the prior application is incorporated herein by reference.

### BACKGROUND OF THE INVENTION

1. Field of the Invention

The present invention relates to the field of online media advertising. More specifically, invention relates to a method and system for launching an advertising campaign.

2. Description of the Prior Art

The digital and online media industry is growing at a rate of 60 to 70 percent year over year. With this growth rate has come a significant challenge in how to manage and use digital and online media. The challenge is particularly onerous for people who seek to use the World Wide Web (WWW) as a forum for advertising.

Online advertising campaigns are typically evaluated in real time, due to their highly volatile nature. For example, advertising campaigns may be as short as one day, or as long as three months. Still further, the advertising campaigns may span across different geographies and be launched in various time zones and languages. Therefore, it is difficult to manage online advertising campaigns effectively.

Furthermore and as persons of ordinary skill are aware, online advertising campaigns may be launched through any one or more of the thousands of publishers world wide. Each of these publishers represents a platform for an ad network, an ad server and a gateway to search for marketing opportunities (also known as a search marketing gateway). In addition, there is no standardization of formats to be used by these publishers.

In light of the foregoing discussion, there is a need for a system that adequately addresses the aforementioned issues and enables a user to select from amongst various publishing opportunities and to efficiently market online. In this regard, the present invention substantially fulfills this need. In this respect, the method and system for launching an advertising campaign according to the present invention substantially departs from the conventional concepts and designs of the prior art, and in doing so provides an apparatus primarily developed for the purpose of launching an advertizing campaign.

### SUMMARY OF THE INVENTION

In view of the foregoing disadvantages inherent in the known types of online advertising campaigns now present in the prior art, the present invention provides an improved method and system for launching an advertising campaign, and overcomes the above-mentioned disadvantages and drawbacks of the prior art. As such, the general purpose of the present invention, which will be described subsequently in greater detail, is to provide a new and improved method and system for launching an advertising campaign and method which has all the advantages of the prior art mentioned heretofore and many novel features that result in a method and system for launching an advertising campaign which is not anticipated, rendered obvious, suggested, or even implied by the prior art, either alone or in any combination thereof.

An embodiment of the present invention provides a method and system for providing an analysis of online advertising to a user. The system includes a scraper module, an indexer module, and a user interface module. The scraper module populates an advertisement database with online media content files, while the indexer module indexes the advertisement database to provide a set of key words corresponding to each online media content file. The user interface module allows the user to input one or more user-defined search criteria. Subsequently, the user interface module searches within these key words to identify a result set of online media content files that satisfy the user-defined search criteria, and displays the result set to the user.

Another embodiment of the present invention provides a method and system for launching an advertising campaign. The system includes a search module, a plan module, a create module, a purchase module and a track module. The search module receives user-defined search criteria and returns results that satisfy the user-defined search criteria.

The plan module receives user-defined campaign criteria, and displays a set of publishers that satisfy the user-defined campaign criteria. The user-defined campaign criteria may, for example, include at least one of one or more publishers, budget for the advertising campaign, duration of advertisement, target geography, target audience, key words and other suitable parameters. The user may choose to either select one or more publishers of his/her interest from the set of publishers, or select all publishers from the set of publishers.

The user may select an already existing advertising, or optionally, use the create module to create an advertisement for the advertising campaign. In accordance with a specific embodiment of the present invention, the create module also includes an optimizer module that optimizes the size of the advertisement based on portal centric parameters. The purchase module then places an order for publishing the advertisement campaign through the publishers selected by the user.

Finally, the user may use the track module to track the advertising campaign. The track module monitors click throughs and/or impressions of an advertisement that has been placed with a publisher.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Through various embodiments of the present invention, one may accomplish one or more of the following benefits: (i) vertical integration of a plurality of aspects pertaining to online media advertising; (ii) automation of researching, planning, creating, purchasing and/or tracking online advertising campaigns, thereby increasing efficiency; and (iii) introducing effective data mining capabilities as a tool for market research to enable the mapping of user trends.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

Embodiments of the present invention will hereinafter be described in conjunction with the appended drawings provided to depict and not to limit the present invention, wherein like designations denote like elements, and in which:

FIG. 1 depicts a network environment, wherein an embodiment of the present invention may be practiced;

FIG. 2 is a block diagram depicting a system for launching an advertising campaign, in accordance with an embodiment of the present invention;

FIG. 3 is a block diagram depicting a system for providing an analysis of online advertising to a user, in accordance with an embodiment of the present invention;

FIG. 4 is a block diagram depicting a system for purchasing an advertisement, in accordance with an embodiment of the present invention;

FIG. 5 depicts a method of launching an advertising campaign, in accordance with an embodiment of the present invention; and

FIG. 6 depicts a method of searching and selecting advertisements, in accordance with an embodiment of the present invention.

### DESCRIPTION OF THE PREFERRED EMBODIMENT

As used in the specification and claims, the singular forms “a”, “an” and “the” include plural references unless stated otherwise. For example, the term “an advertising campaign” may include a plurality of advertising campaigns unless stated otherwise.

Embodiments of the present invention provide a method and system for providing an analysis of online advertising to a user, a method and system for launching an advertising campaign, and a method and system for purchasing an advertisement. In the description herein for embodiments of the present invention, numerous specific details are provided, such as examples of components and/or mechanisms, to provide a thorough understanding of embodiments of the present invention. One skilled in the relevant art will recognize, however, that an embodiment of the present invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Sectional headers provided in this description are provided for the purpose of assisting the reader in understanding where a description of a particular aspect of the invention is located. It is understood that aspects of the present invention may also be provided throughout the description, drawings and claims. Thus, the headers do not limit the invention in any way.

Unless otherwise specified or apparent from context, the following terms and phrases have the meanings provided below:

The phrase “ad content” refers to the elements of an advertisement, including but not limited to the advertisement's text, description, images, artwork and logos.

The phrases “ad network” and “advertising network” refer to a network that connects web sites that host advertisements with advertisers that are designed to run advertisements. Examples of a network may include, advertising companies, online advertising websites and the like.

The terms “ad server” refers to a web server that hosts advertisements that are used in online marketing. The content of the web server is constantly updated so that the web site or web page on which the ads are displayed contains new advertisements—e.g., banners (static images/animations) or text—when the site or page is visited or refreshed by a user. An ad server may also perform various other tasks including but not limited to counting the number of impression/clicks for an ad campaign and report generation, which helps in determining the return on investment for an advertiser on a particular web site.

The term “coupled” means that after accessing one module or system a second module or system may be accessed without opening or closing different programs. The modules and/or systems may include one or more hardware, software, or hybrid components residing in or distributed among one or more local or remote computers. The modules may be physically separated or together and may each be a logic routine or part of a logic routine that carries out the embodiments disclosed herein.

The term “crawling” refers to browsing the world-wide-web or other network through the use of a program or automated script in a methodical, automated manner.

The phrase “creative piece” refers to the concept, design and artwork in an advertisement.

The phrase “fetcher thread” refers to the instruction to look to a particular during a web crawl.

The term “Flash” refers to a set of multimedia technologies that is distributed by Adobe Systems. It is a well-known method for adding animation and interactivity to web pages. It is commonly used to create animation, advertisements and various web page components for integration into web pages. When reference is made herein to Flash technology, it is understood to refer to systems that have the similar operating capabilities.

The phrase “headless browser” refers to a browser object that does not have an attached user interface component. Headless browsers make it possible to run web application tests in the background. When a test fails and requires debugging, one can switch to a version of the test with a graphic user interface browser for a better understanding of what is occurring.

The term “impression” refers to an instance in which an advertisement is viewed. This applies particularly to online advertising. A single user often gets several impressions as he browses through a web site.

The term “indexing” refers to collecting parses and storing data in order to facilitate fast and accurate information retrieval. Index design incorporates interdisciplinary concepts from linguistics, cognitive psychology, mathematics, informatics, physics and computer science.

The phrase “internal database feed” refers to a set of database lists generated by a set of people/users that is fed into the systems of the present invention. It may provide the list of URLs to be scraped.

The phrase “IP mapping” refers to the Internet Protocol, which is a means of finding out where a user is based and based on the location of the user, providing demographic specific content.

The phrase “key word” refers to a word that may be present in an online media file, e.g., in a meta-tag and/or text file and/or flash file. A key word listing may include all words that appear as meta-tags or text or components of a flash file in online media files that have been reviewed or a subset of terms that appear in meta-tags.

The phrases “landing page” and “lead capture page” are used interchangeably and refer to the web page that appears when a potential customer clicks on an advertisement or a search-engine result link. The page will usually display content that is a logical extension of the advertisement or link, and that is optimized to feature specific key words or phrases for indexing by search engines.

The phrase “module” refers to a computer program product that may be stored on hardware and/or software that may be activated by a user to carry out a defined set of steps and/or to prompt a user to provide information through, for example, a graphic user device and/or input/output device. Each module may be used on a separate platform or a plurality of modules may be run off of the same platform.

The term “multimedia” refers to information that can sustain text, images, audio, video and/or any other type of information, e.g., an online format.

The phrase “online advertising” refers to a form of advertising that uses the Internet and the World Wide Web in order to deliver marketing messages and to attract customers.

The phrase “online media” refers to Internet sites or servers in which content is available for browsers. Internet sites may for example be written in various formats, including but not limited to html, and they are viewable through an Internet browser.

The phrase “operably coupled” refers to any connection that allows interoperability, including for example, being communicably coupled.

The phrase “representational state transfer” and the acronym “REST” are used interchangeably and refer to a stateless client-server architecture in which web services are viewed as resources and can be identified by their URLs. Web service clients who want to use these resources may access a particular representation by transferring application content using a small globally defined set of remote methods that describe the action to be performed on the resource. REST is an analytical description of the existing web architecture and thus the interplay between the style and the underlying http protocol appears seamless.

The phrase “rich media” refers to a web page advertisement that uses technology such as streaming video, downloaded applets (programs) that interact instantly with the user, and advertisements that change when the user's mouse passes over it.

The term “scraping” refers to a technique in which a computer program extracts data from the display output by another program.

The abbreviation “URL” refers to a uniform resources locator.

The term “portal” refers to publishers, ad networks, ad servers, search marketing gateways, social networking sites, and other web sites related to advertising. Terms “publisher”, “portal”, “ad server”, “ad network”, “search marketing gateway”, and “social networking site” have been used interchangeably throughout the disclosure, and should not be construed as limiting the scope to a specific term only. Apart from online advertising on Internet web pages and web sites, embodiments of the present invention also encompass advertising via mobile phones, WiMAX, IP Television (IPTV), Out Of Home (OOH) digital media, and other related technologies.

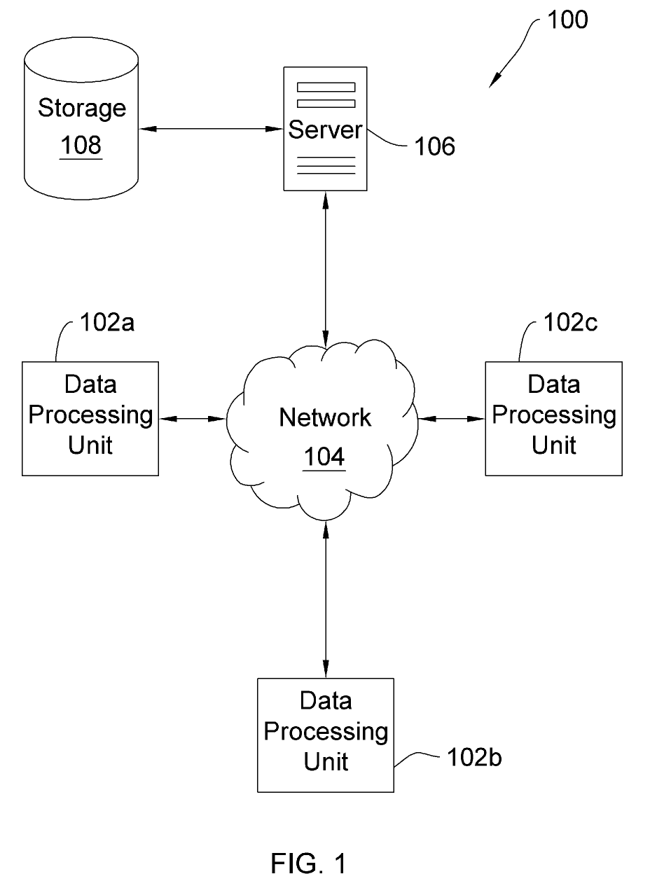

FIG. 1 depicts a network environment 100, wherein embodiments of the present invention may be practiced. Network environment 100 includes a plurality of data processing units, such as a data processing unit 102a, a data processing unit 102b and a data processing unit 102c. Data processing unit 102a, data processing unit 102b and data processing unit 102c are hereinafter referred as data processing units 102. Examples of data processing units 102 include, but are not limited to computers, laptops, Personal Digital Assistants (PDAs), and mobile phones.

Data processing units 102 are connected to each other through a network 104. In an embodiment of the present invention, network 104 is a collection of individual networks, interconnected with each other and functioning as a single large network. Network 104 may be a wireless or a wired network. Examples of network 104 include, but are not limited to, Local Area Networks (LANs), Wide Area Networks (WANs), Peer-to-Peer (P2P) networks, Metropolitan Area Networks (MANs), and the Internet.

Network environment 100 also includes a server 106 and a storage 108 associated with server 106. In accordance with an embodiment of the present invention, storage 108 includes an advertisement database on which server 106 stores and maintains various online advertisements.

The advertisements may, for example, be categorized into a plurality of categories, based on the file format of the advertisement, such as swf, flv, jpeg, gif, mpeg, and other rich media formats. For example, an advertisement in swf format may be categorized under category, swf, while an advertisement in jpeg format may be categorized under category, jpeg.

Alternatively, the advertisements may be categorized into a plurality of categories, based on the context of the advertisements. For example, an advertisement related to a football match may be categorized under a category, Sports, while an advertisement related to a music concert may be categorized under a category, Music. In addition, each category may further be divided into sub-categories. For example, the category, Sports, may be divided into sub-categories, Football, Baseball, Basketball, and so on.

In addition, the advertisements are stored along with key words corresponding to the context of the advertisements, brand names associated with the advertisements, and so on.

Apart from the advertisement database, storage 108 may also include a publisher database on which server 106 stores and maintains information about various online and offline publishers.

It is to be understood that the specific designation for data processing units 102, server 106 and storage 108 is for the convenience of the reader and is not to be construed as limiting network environment 100 to a specific number of data processing units 102, server 106 and storage 108 or to specific types of data processing units 102, server 106 and storage 108 present in network environment 100. For example, network environment 100 may include one or more auxiliary servers supporting server 106.

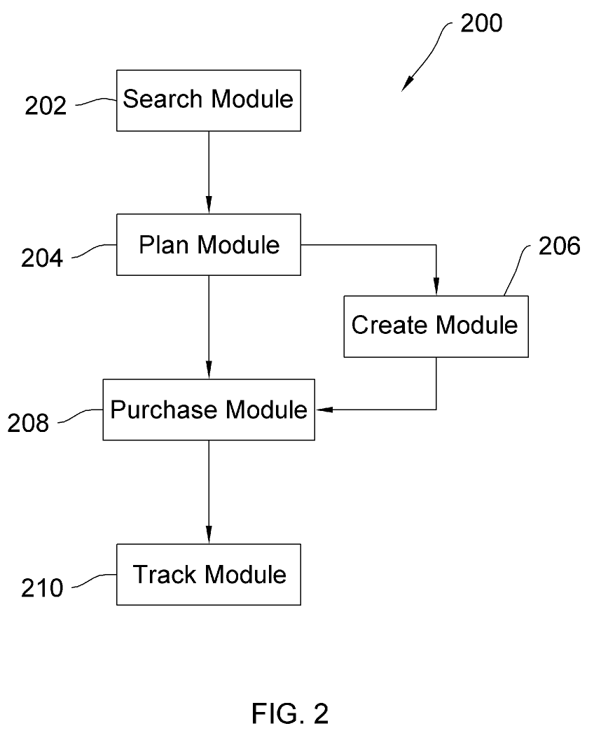

FIG. 2 is a block diagram depicting a system 200 for launching an advertising campaign, in accordance with an embodiment of the present invention.

An advertising campaign, regardless of the type of media on which the advertising campaign is launched, includes five basic parts: (1) competitive analysis, (2) media planning, (3) creating advertisements, (4) publishing the advertisements across various publishers, and (5) tracking whether the advertisements are seen through a particular publisher and/or whether the advertising campaign leads to increased business. Accordingly, system 200 includes various modules corresponding to each of these parts, shown as a search module 202, a plan module 204, a create module 206, a purchase module 208, and a track module 210.

Consider, for example, that a user inputs one or more user-defined search criteria into search module 202. Accordingly, search module 202 displays a result set of online media content files that satisfy the user-defined search criteria.

The user may then input one or more user-defined campaign criteria into plan module 204. The user-defined campaign criteria may, for example, include at least one of one or more publishers, budget for the advertising campaign, duration of advertisement, target geography, target audience, key words and other suitable parameters. Accordingly, plan module 204 prepares a media plan satisfying the user-defined campaign criteria that describes opportunities for advertising with various publishers. For example, plan module 204 may display a set of potential publishers that satisfy the user-defined campaign criteria. The user may choose to either select one or more publishers of his/her interest from the set of publishers, or select all publishers from the set of publishers.

The user may then optionally use create module 206, which allows him/her to follow a step-by-step process for creating an advertisement. Alternatively, the user may select advertisements created by him/her earlier. The user may also use an optimization module, a sub-module of create module 206, that optimizes the advertisement specific to the requirements of potential publishers.

Subsequently, the user may use purchase module 208 to place an order for purchasing advertising opportunities from the potential publishers selected earlier. Accordingly, purchase module 208 prepares media booking orders for each campaign to be launched with each potential publisher. Upon confirmation from the user, purchase module 208 may then release invoices, and track payments corresponding to the advertising campaign.

Once an advertisement campaign is launched, the user may keep a track of the performance of the advertising campaign through track module 210.

FIG. 2 is merely an example, which should not unduly limit the scope of the claims herein. It is to be understood that the specific designation for system 200 is for the convenience of reader and is not to be construed as limiting system 200 to specific numbers, types, or arrangements of components of system 200. One of ordinary skill in the art would recognize many variations, alternatives, and modifications of embodiments of the present invention. For example, each of the modules may be operably coupled to one or more of the other modules. In addition, these modules may be used alone or in any combination, in accordance with various embodiments of the present invention. Furthermore, these modules may be located on different servers at different geographic locations.

### Search Module

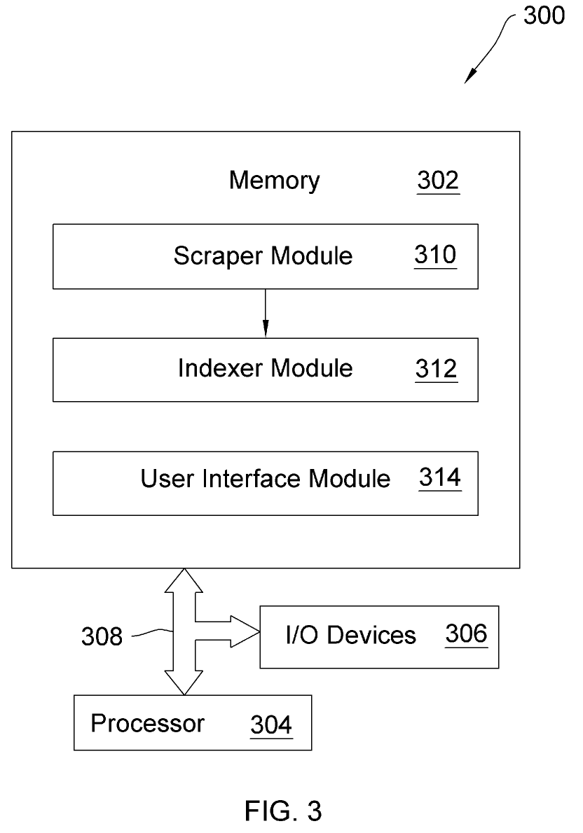

FIG. 3 is a block diagram depicting a system 300 for providing an analysis of online advertising to a user, in accordance with an embodiment of the present invention. System 300 may, for example, be implemented as search module 202 in FIG. 2.

System 300 includes, but is not limited to, a memory 302, a processor 304, Input/Output (I/O) devices 306, and a system bus 308 that operatively couples various components including memory 302 and processor 304. Memory 302 stores a scraper module 310, an indexer module 312, and a user interface module 314. Each of these modules may be operably coupled to one another, or may be a separate module in and of itself.

When executed on processor 304, scraper module 310 populates an advertisement database with online media content files. The media content files may, for example, be in the form of flash, swf, flv, jpeg, gif, mpeg and other rich media formats, as well as combinations thereof.

Scraper module 310 may, for example, first scrap through a pre-fed list of Uniform Resource Locators (URLs). The list may, for example, come from feed designed to self-generate content from external crawling and internal database feed. In certain embodiments, humans identify and input a list of URLs into a URL database. Identification of publishers and pre-fed lists of URLs may be obtained by, for example, obtaining an index of well-known publishers of online media, reviewing the web sites of these publishers to determine whether these publishers display a threshold number and/or frequency of advertisements, and manually typing the URLs of these publishers into the URL database. By way of example, the database may include a list of URLs that are known to be sites on which online media content is published.

Additionally, information about various publishers may be obtained through traditional search engines, like Google™ and Yahoo™. Potential publishers may then be identified from the various publishers, based on certain criteria, e.g., meta-tag composition or impression frequency.

In certain embodiments, scraper module 310 extracts content by scraping frames of a content page in which an advertisement appears. Scraper module 310 is capable of scraping both text and visual media including, but not limited to, flash, swf, flv, jpeg, gif, mpeg and other rich media formats. Accordingly, scraper module 310 may scan a web page for predefined file formats. Appropriate media content files are identified by their file extensions.

Scraper module 310 may also be programmed such that if during a process of scraping a page, it is found that the page includes a direction to other URLs, these other URLs may also be accessed and then used for scraping.

In accordance with an embodiment of the present invention, scraper module 310 scrapes through the list of URLs on a first in first out (FIFO) basis, wherein the URLs are analyzed in an order determined by the list of URLs.

In accordance with an embodiment of the present invention, scraper module 310 assigns a fetcher thread to each URL. The fetcher thread queries REST web services, which in turn, may use a headless browser to fetch a web page and to return the web page back to the thread. The fetcher thread may make use of various proxy servers for IP mapping. This process may be repeated for each link within each URL. Thus, there are multiple threads running for the same and multiple publishers, and each thread has a potential to link to other URLs, thereby initiating the scraping of more sites.

Consider, for example, that the URL of Yahoo™ is provided for scraping. Accordingly, a headless browser indexes all links on the URL and scrapes each link. During scraping, each web page of each link may be analyzed for the presence of media files, which are then examined for the presence of clickTags. If there is a clickTag, the clickTag may be used to direct scraper module 310 to a landing page. On that landing page, meta-tags are analyzed for key words and for brands, which may be denoted as titles on that landing page. Finally, these key words and brands are saved in the advertisement database along with the advertisements with which they are related. The online media content files may be saved in a plurality of file formats, and the key words may be in a single file format or in a plurality of file formats.

In some embodiments, the advertisement database may include identification of a publisher, click through information and placement of the advertisement for a plurality if not all advertisements.

In other embodiments, the advertisement database may be indexed based on a predefined schema. The predefined schema may, for example, be defined by the user, or by default. The predefined schema may, for example, include fields for identification of an advertisement, key words associated with the advertisement, the size of the advertisement, geography and demography where the advertisement is published, identification of one or more publishers who published the advertisement, information about click throughs and/or impressions, the file format, the file name, the location where the advertisement is stored and so on.

If a media content file is in the form of a Flash file, scraper module 310 may obtain key words for indexing from the meta-tags of the Flash file and/or by directly reading and ripping the meta-tags from the Flash file. Thus, there are two ways to obtain key word information from a Flash file.

By contrast, if the media content file is not a Flash file, then scraper module 310 may go to the landing page that the media content file identifies and extract the key words. Media content files in image format may, for example, be analyzed for advertisement dimensions in order to determine whether they satisfy predetermined banner ad criteria. If the banner ad criteria are satisfied, these media content files are downloaded and stored as advertisements in the advertisement database.

The scraping and subsequent indexing may be done in real time and updated regularly or irregularly. In some embodiments, scraper module 310 is activated to access URLs at a predetermined frequency. For example, the scraping and indexing may be repeated daily, twice a day, hourly, twice an hour, every five minutes, every minute, every second or every millisecond. In other embodiments, scraper module 310 is activated after a user query is received.

In certain embodiments, scraper module 310 is browser based. Thus, the user may access scraper module 310 over a network, such as the Internet, through his/her browser.

It is within the spirit and the scope of scraper module 310 for a user to tap into an already indexed database or to initiate a new scraping process that will create a new database or add to an existing database. Further, scraper module 310 may have a pre-fed list of URLs that are to be scraped, invite the user to create his own list from scratch, invite the user to supplement the list of URLs that already exists in scraper module 310, invite the user to select a subset of URLs from the list of URLs and/or invite the user to supplement a subset of the list of URLs.

In certain embodiments, scraper module 310 analyzes a plurality of links of a URL for media content files that have an extension of at least one of swf, flv, jpeg, gif, mpeg or other rich media formats, and reviews corresponding landing pages for meta-tags. If meta-tags are present, the associated media content file is saved along with information extracted from the meta-tags.

When executed on processor 304, indexer module 312 analyzes the media content files downloaded by scraper module 310. Indexer module 312 categorizes the media content files into various media types, in accordance with an embodiment of the present invention. Each media content file may be analyzed using, for example, a third party library of java files to identify key words. For example, each media content file is processed to identify key words that define the context of that media content file. Subsequently, the identified key words are stored in the advertisement database, such that each media content file is associated with its respective key words. An exemplary program for indexing is available from J. Generator by Dimitri Scavish.

As persons of ordinary skill are aware, a clickTag is a tracking code assigned by an ad serving network to an individual advertisement. The clickTag allows the network to register where the advertisement was displayed and when a user clicks on it. This click through data is then reported to the ad servers so that advertisers may determine the effectiveness of a campaign. This service is available through, for example, Macromedia. Indexer module 312 may obtain this information (e.g., through scraper module 310 or other appropriate modules) and index this information (click throughs and/or impressions) as well for later searching.

In accordance with another embodiment of the present invention, scraper module 310 may be capable of scraping a frame of an online content page in which an advertisement appears, thereby yielding a scraped frame. Accordingly, indexer module 312 may be configured to extract key words from the scraped frame. Indexer module 312 may be configured to be able to extract the key words from a plurality of file formats and to generate an index of key terms.

In accordance with an alternative embodiment of the present invention, scraper module 310 may extract the key words, while indexer module 312 may index them. In this way, certain functions of scraper module 310 and indexer module 312 may be interchangeable, or scraper module 310 and indexer module 312 may be combined together to form a single module.

Processor 304 may be used to enable any module of system 300 to be coupled to any one or more other modules. In accordance with various embodiments of the present invention, processor 304 has the ability to access the Internet, and optionally is continuously or continually linked to the Internet to provide for rapid access to the desired URLs by scraper module 310.

When executed on processor 304, user interface module 314 collates the information from scraper module 310 and indexer module 312, and acts as a gateway for users to search queries and to retrieve results. The search may, for example, be used for querying brands and/or key words. User interface module 314 may, for example, receive one or more user-defined search criteria from the user. The user-defined search criteria may, for example, include brand, key words, demography and other suitable options. Accordingly, user interface 314 may associate the advertisement database with the user-defined search criteria, and retrieve a result set of advertisements that satisfy the user-defined search criteria.

In accordance with a specific embodiment of the present invention, search module 202 transmits information stored on the advertisement database to an Apache Solr server, which indexes the information based on a predefined schema as described above. In this way, the same information may be indexed at multiple locations, thereby enabling a failsafe mechanism in case of failure at a particular server. When a user enters one or more user-defined search criteria, the user-defined search criteria may be sent to the Apache Solr server, which then retrieves results satisfying the user-defined search criteria. In addition, the Apache Solr server fastens the processing of user queries.

In accordance with an embodiment of the present invention, the user may also be allowed to define the format in which the user desires to the results to be displayed. Accordingly, the server may store the format defined by the user as his/her preferences.

In accordance with a specific commercial embodiment of the present invention, search module 202 may display the results in a custom Flash loader. This prevents the user from downloading the original advertisements.

In accordance with an embodiment of the present invention, search module 202 may be used to provide a competitive analysis of online advertising to the user. In such a case, the user may provide brands of his/her competitors and/or key words defining the industry specific to the user as user-defined search criteria. Accordingly, search module 202 retrieves a result set that satisfies the user-define search criteria. The user may then review the result set to identify where and how his/her competitors are advertising. This information helps the user to plan a strategy for his/her advertising campaign accordingly.

FIG. 3 is merely an example, which should not unduly limit the scope of the claims herein. It is to be understood that the specific designation for system 300 is for the convenience of reader and is not to be construed as limiting system 300 to specific numbers, types, or arrangements of components of system 300. One of ordinary skill in the art would recognize many variations, alternatives, and modifications of embodiments of the present invention.

### Plan Module

After or before searching, the user may activate plan module 204. The plan module 204 includes a web-based platform that includes a front end (user interface) and a back end (modules). The front end assimilates data based on permutations and combinations of pre-fed real time data in the back end. The back end includes a publisher database of a plurality of portals, publishers and/or ad networks. The publisher database stores and maintains information about inventory availability, creative size weights, prices, etc. with respect to each publisher, and also assigns a unique identification code to each publisher. Thus, the front end assimilates the data based on the parameters provided and the back end matches the parameters with potential publishing opportunities.

On the front end, the user inputs information such as that selected from the following list: budget, desired duration of time in which advertisement will run, location in which advertisement will run, key words, target audience and combinations thereof.

The variables are then scored against one or more variables selected from the following non-exhaustive list of publishers or publishing opportunities: (a) web site for advertisement placement; (b) region of placement; (c) market; (d) vertical connections; (e) monthly impressions; (f) unique users; (g) country wide IP impressions; (h) availability of creative sizes; (i) permissible creative weights; (j) permissible innovations; (k) property placements; (l) pricing in multiple currencies; (m) minimum buy; (n) rates; (o) taxes; (p) discounts; and (q) contact information.

Through this matching and scoring, the user may be provided with a media plan for advertising. Accordingly, the front end displays this information in the form of a media plan or a number of media plan options to the user. The media plan may also be downloaded on a computer hard drive or other electronic media.

### Create Module

Create module 206 is an optional module that permits the user to use a do-it-yourself web platform. The user may be guided through a clear path of creating advertisements without having to understand the technical nuances. Thus, one may use a library of backgrounds, illustrations, fonts and preset animations to create advertisements.

For example, create module 206 may through a graphic user interface permit a user to do one or more of the following actions: (1) defining the size and weight of a banner; (2) defining the number of frames for the banner; (3) filling background images and/or color for the frames; (4) inserting images for the library at preset space allocations; (5) inserting text after selecting a font from the library; (6) inserting company logo from a desired file at preset locations; and (7) downloading or saving the advertisement for future use. In accordance with an embodiment of the present invention, create module 206 allows the user to download or save the advertisement after making a payment for the same through, e.g., an online payment gateway. The order of these steps as described in this paragraph is an exemplary order in which a user may perform them.

In accordance with an additional embodiment of the present invention, create module 206 may allow the user to create a click to call feature for an advertisement. The click to call feature may be used by the user to define a contact number where he/she wishes to receive a call from someone who clicks on the advertisement. Accordingly, the user may set a number of parameters, such as geographies where the advertisement can be seen, time duration of the call, preferred time when the call can be received, etc. A click to call feature may be activated or deactivated depending on the user's preference. For example, the click to call feature may be deactivated if it does not meet a minimum budget criteria.

By way of example, the user may login to a computer-based platform and select to create rich media advertisement or a graphical advertisement. From there, the user may be guided to specify dimensions according to various standards, create a background using the tools provided, specify effects and other parameters, and optimize the advertisement based on portal centric parameters. In a commercial embodiment, the user may then be asked to pay for the transaction. The advertisement may be saved and uploaded to the user's account after the payment process is complete. Alternatively, there may be no payment process and/or the advertisement could be released or previewed prior to payment.

Because publishers use a variety of sizing parameters, if a publisher were selected prior to the creation of an advertisement and its sizing requirements were known, it may be advantageous to limit the user's choices to be consistent with those requirements.

Alternatively, if the publisher were not initially known, or its sizing parameters are not known, create module 206 may include an optimizer module that enables resizing in a plurality of formats that would be acceptable to a plurality of publishers. For example, after a user uploads a rich media advertisement or graphical advertisement, he/she may run the optimizer module that analyzes the advertisement using a swf library or graphics module and then optimize the advertisement based on portal centric parameters.

### Purchase Module

Purchase module 208 serves as an aggregator of the data from the other modules described above or from an external source when users feed their own plans and advertisements instead of using plan module 204 and create module 206. Purchase module 208 offers a single gateway through which to buy media from thousands of publishers, ad networks, ad servers and search marketing gateways. In some embodiments, purchase module 208 queries only publishers that have published advertisements that appeared in the results of search module 202. In other embodiments, purchase module 208 queries a broader set of publishers. In some embodiments, purchase module 208 queries an overlapping set of publishers that includes publishers that have advertisements that appear in the results and those that do not have advertisements that appear in the results.

In accordance with an embodiment of the present invention, purchase module 208 may allow the user to review results obtained from search module 202. Purchase module 208 may also allow the user to apply one or more user-defined criteria with respect to at least one publisher. The user defined criteria may include one or more of the following: budget, location, key words, target audience, and duration of advertisement. Accordingly, purchase module 208 then selects one or more publishers that satisfy the user defined criteria for launching an advertising campaign.

The user defined criteria may then be measured against one or more of the following parameters of a publishing opportunity: (a) web site for advertisement placement; (b) region of placement; (c) market; (d) vertical connections; (e) monthly impressions; (f) unique users; (g) country wide IP impressions; (h) availability of creative sizes; (i) permissible creative weights; (j) permissible innovations; (k) property placements; (l) pricing in multiple currencies; (m) minimum buy; (n) rates; (o) taxes; (p) discounts, if any; and (q) contact information.

If the user has used all of the above steps, then his/her campaign is ready to go live. He/she may then select a purchase option in the media plan to generate a single media booking order (or a plurality of media booking orders). The media booking order may, for example, state all of the details of the advertising campaign, which include some or all of: (1) vehicle publisher; (2) campaign name; (3) campaign duration; (4) number of impressions; (5) creative sizes; (6) property placement; (7) rate; (8) discount, if any; (9) taxes; and (10) net payable amount.

In accordance with an additional embodiment of the present invention, purchase module 208 allows a user to launch an advertising campaign on social networking sites and/or personal web pages of individuals. Accordingly, one or more advertisements corresponding to the advertising campaign may be placed on a social networking profile and/or a personal web page. The social networking profile may, for example, belong to the user, wherein the user may be a representative of a company for which he/she has placed an advertisement in his/her profile. Similarly, the advertisements may be placed on social networking profiles of other representatives of the company.

Additionally, the advertisements may be placed on social networking profiles and/or personal web pages of other individuals and/or companies that may not be directly related to the company. In such a case, an advertisement may be placed on a social networking profile and/or personal web page on permission of the individual and/or company to whom the profile and/or web page belongs. Additionally, the user may buy an advertising space on social network profiles and/or personal web pages of various individuals and/or representatives of partnering companies. Accordingly, purchase module 208 may provide a user interface to the user through which he/she may search through and/or add social network profiles and/or personal web pages on which he/she desires to launch the advertising campaign.

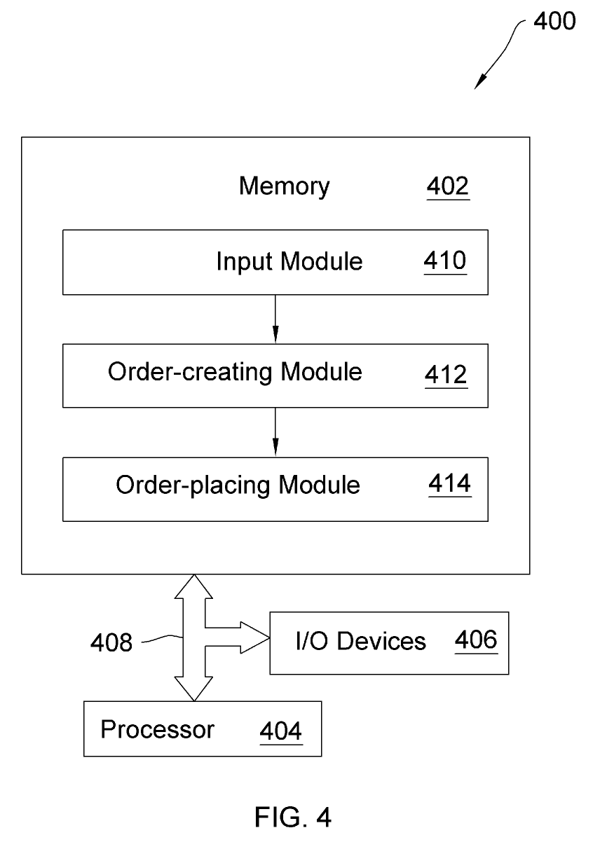

FIG. 4 is a block diagram depicting a system 400 for purchasing an advertisement. System 400 may, for example, be implemented as purchase module 208 in FIG. 2.

System 400 includes, but is not limited to, a memory 402, a processor 404, Input/Output (I/O) devices 406, and a system bus 408 that operatively couples various components including memory 402 and processor 404. Memory 402 stores an input module 410, an order-creating module 412, and an order-placing module 414. Each of these modules may be operably coupled to one another, or may be a separate module in and of itself.

When executed on processor 404, input module 410 receives one or more inputs from a user. These inputs may, for example, include one or more advertisements selected by the user and one or more publishers selected by the user. The selection may, for example, follow from plan module 204 and create module 206, as described above. Alternatively, the user may upload other advertisements stored on a data processing unit from which he/she is accessing purchase module 208, and may provide a list of publishers of his/her own.

When executed on processor 404, order-creating module 412 automatically create one or more media booking orders, based on the user's inputs. For example, if the user selects the advertisements and publishers for the advertisement campaign, and opts to launch the campaign, order-creating module 412 creates multiple media booking orders, at least one for each publisher.

In accordance with an embodiment of the present invention, order-creating module 412 associates each publisher with a unique launch code, and creates the media booking orders corresponding to the unique launch codes of the publishers. For example, when the user selects publishers using plan module 204, order-creating module 412 may use the unique identification code previously assigned to the publishers as the unique launch code. In another example, when the user adds some publishers on his/her own, order-creating module 412 may assign a new unique launch code to each publisher. Accordingly, multiple advertising campaigns launched with a particular publisher may be associated with the unique launch code of that publisher.

Similarly, order-creating module 412 may also assign a unique identification code to each user, whereby advertising campaigns launched by a particular user may be associated with the unique code of that user.

When executed on processor 404, order-placing module 414 places these media booking orders for launching the selected advertisements with the selected publishers. In accordance with an embodiment of the present invention, order-placing module 414 generates invoices, upon confirmation of media booking orders by the user.

In accordance with an embodiment of the present invention, purchase module 208 allow the user to create multiple media booking orders for multiple advertising campaigns with multiple publishers in a single step. For example, a user interface may display a list of advertisements created and/or uploaded by the user and a list of publishers. In such a case, purchase module 208 may consider one or more media plans provided by plan module 204, wherein the user may select a plurality of publishers from these media plans. The user may select one or more advertisements from the list of advertisements for launch with the selected publishers. Upon confirmation, purchase module 208 may then automatically prepare a plurality of media booking orders corresponding to the selected advertisements and publishers. In this way, several advertising campaigns may be launched simultaneously in a single step.

FIG. 4 is merely an example, which should not unduly limit the scope of the claims herein. It is to be understood that the specific designation for system 400 is for the convenience of reader and is not to be construed as limiting system 400 to specific numbers, types, or arrangements of components of system 400. One of ordinary skill in the art would recognize many variations, alternatives, and modifications of embodiments of the present invention.

I/O devices 306 and I/O devices 406 represent any devices through which system 300 and system 400 receive input from and/or display outputs to the user. Examples of I/O devices 306 and I/O devices 406 include, but are not limited to, a display screen, such as a Cathode Ray Tube (CRT) monitor, a Liquid Crystal Display (LCD), a Plasma Display Panel (PDP) and any projected display, a keyboard, and a pointing device, such as a mouse, a touch-sensitive screen, a trackball, a touchpad, a joystick, a pointing stick, and a graphics tablet with a pen.

Memory 302 and memory 402 include computer-readable media in the form of volatile memory, such as Random Access Memory (RAM) and/or non-volatile memory, such as Read Only Memory (ROM) or flash RAM. Memory 302 and memory 402 typically contain data and/or program modules for implementing embodiments of the present invention that are immediately accessible to and/or presently operated on by processor 304 and processor 404, respectively.

System bus 308 and system bus 408 represent any of the several types of bus structures, including a memory bus or memory controller, a peripheral bus, an accelerated graphics port, and a processor bus or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, a Peripheral Component Interconnects (PCI) bus also known as a Mezzanine bus, a PCI Express bus, a Universal Serial Bus (USB), a Secure Digital (SD) bus, or an IEEE 1394 (i.e., FireWire) bus.

### Track Module

Track module 210 is an integration with ad servers and ad networks that tracks, for example, the performance of an advertising campaign with parameters including click throughs, impressions, and conversion rates. Exemplary tracking modules would be those modules that allow communication with, integration with or use of tracking technology such as Doubleclick, Zedo and BrandCentral. A tool such as clickTag can be used to embed the advertisement with a code that is given to publishers. When an impression is made or a click through is activated, the occurrence is registered and optionally demographic information of the server, location, etc. of the user who viewed and/or clicked through is registered as well.

In accordance with an embodiment of the present invention, track module 210 displays a list of ad servers, and provides an option to the user to select one or more ad servers for tracking the advertising campaign.

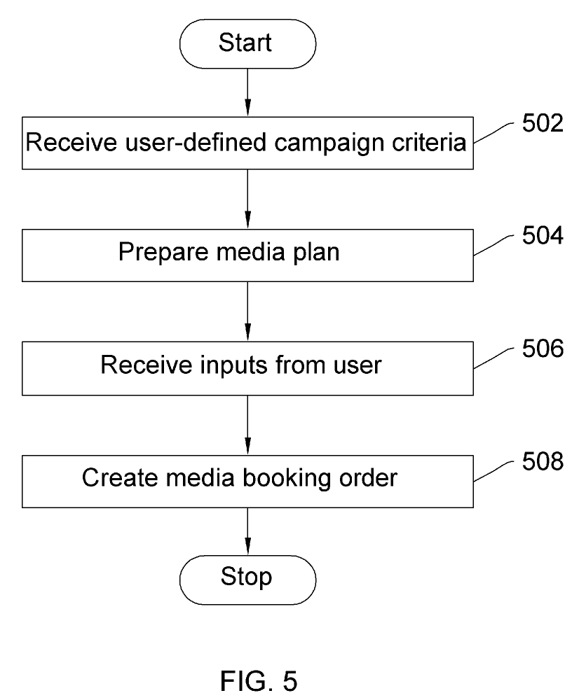

FIG. 5 depicts a method of launching an advertising campaign, in accordance with an embodiment of the present invention. The method is illustrated as a collection of steps in a logical flow diagram, which represents a sequence of steps that can be implemented in hardware, software, or a combination thereof.

At step 502, one or more user-defined campaign criteria are received from a user. The user-defined campaign criteria may, for example, include at least one of one or more publishers, budget for the advertising campaign, duration of advertisement, target geography, target audience, or key words.

Subsequently, at step 504, a media plan satisfying the user-defined campaign criteria is prepared.

At step 506, one or more inputs are received from the user. The inputs include one or more advertisements and one or more publishers selected by the user. In accordance with an embodiment of the present invention, at least one user profile and/or personal web page is selected as a publisher.

In accordance with an embodiment of the present invention, an additional step of creating an advertisement may be performed. In accordance with an additional embodiment of the present invention, an additional step of allowing the user to add a click to call feature to an advertisement may be performed.

Subsequently, at step 508, one or more media booking orders are automatically created, based on the inputs.

In accordance with an embodiment of the present invention, each publisher is associated with a unique launch code, such that advertising campaigns launched with a publisher are associated with the unique launch code of the publisher. In accordance with an additional embodiment of the present invention, each user is associated with a unique identification code, such that advertising campaigns launched by a user are associated with the unique identification code of the user.

In addition, an additional step of tracking the advertising campaign may be performed.

It should be noted here that steps 502-508 are only illustrative and other alternatives can also be provided where steps are added, one or more steps are removed, or one or more steps are provided in a different sequence without departing from the scope of the claims herein.

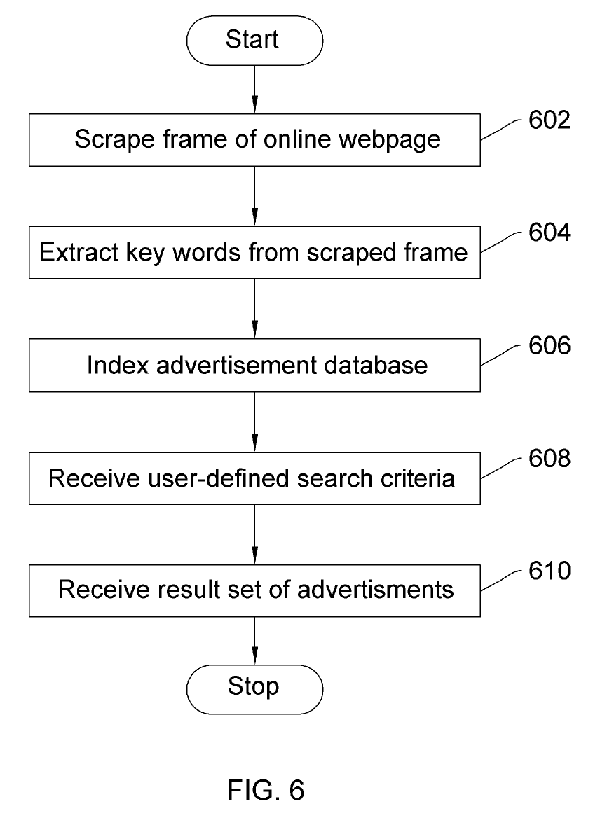

FIG. 6 depicts a method of searching and selecting advertisements, in accordance with an embodiment of the present invention. The method is illustrated as a collection of steps in a logical flow diagram, which represents a sequence of steps that can be implemented in hardware, software, or a combination thereof.

At step 602, at least one frame of each online web page in which an advertisement appears is scraped, thereby yielding at least one scraped frame. At step 604, key words are extracted from the at least one scraped frame to populate an advertisement database with a plurality of advertisements.

At step 606, the advertisement database is indexed based on a predefined schema. As described earlier, the predefined schema includes fields corresponding to at least one of identification of an advertisement, key words associated with the advertisement, the size of the advertisement, geography and demography where the advertisement is published, identification of one or more publishers who published the advertisement, information about click throughs and/or impressions, the file format, the file name, and the location where the advertisement is stored.

Next, at step 608, one or more user-defined search criteria are received from the user. Subsequently, at step 610, a result set of advertisements that satisfy the user-defined search criteria is retrieved from the advertisement database.

It should be noted here that steps 602-610 are only illustrative and other alternatives can also be provided where steps are added, one or more steps are removed, or one or more steps are provided in a different sequence without departing from the scope of the claims herein.

Various advantages of embodiments of the present invention may be apparent from the following discussion. Search module 202 enables a user to review the placement and other parameters of a database of online advertisements that have previously been scraped and indexed, or to initiate new scraping and indexing and thus search what has newly been indexed. Search module 202 may be configured to offer one or more of the following options or benefits: IP targeting, text focus, display focus, brand focus, live feed publisher networks, campaign archive data, and free access.

With the results of the search, a user may strategically use plan module 204 to determine how and where to launch an advertising campaign. Plan module 204 may be configured to offer one or more of the following options or benefits: IP targeting, an intelligent analytics planner, publisher focus, and a source of revenue generation.

If the user has already created the advertisement, the user may engage purchase module 208 through which the user may purchase and direct the dissemination and posting of the online and offline content spots. Purchase module 208 may offer one or more of the following benefits or options: ad serving, integration, and a feed for searching.

If the user has not already created his/her advertisement, and wishes to modify an already-existing advertisement, he may activate create module 206. Create module 206 may offer one or more of the following benefits or options: creative generator library, portal focused creative optimizer, launch code generator for ad serving networks and a source of revenue generation.

After the advertising campaign is launched, the user may monitor the number of impressions (viewings by persons) and click-throughs through track module 210. Track module 210 may be configured to offer one or more of the following benefits or options: pre-negotiated pricing, single insertion order, inventory availability, credit ratings and a loyalty program.

In accordance with an additional embodiment of the present invention, plan module 204, create module 206 and purchase module 208 may enable the user to launch an offline advertising campaign. Accordingly, plan module 204 may prepare a media plan for offline advertising that considers offline publishing opportunities, for example, on Direct To Home (DTH) service, television, news paper, magazines, etc. In such a case, the publisher database may include information about offline publishers as well. Accordingly, plan module 204 and create module 206 may be used to create appropriate media plans and advertisements, while purchase module 208 may be used to purchase offline advertising campaigns.

It will be apparent to those skilled in the art that various modifications and variations can be made to various embodiments described herein without departing the spirit or scope of the teachings herein. Thus, it is intended that various embodiments cover other modifications and variations of various embodiments within the scope of the present teachings. Further, unless otherwise specified or apparent from context any feature described in connection with any one embodiment described above, may be used in connection with any other embodiment.

What is claimed is:

1. A system for launching an advertising campaign, the system comprising:
a memory;
a processor operatively coupled to the memory;
a plan module stored on the memory and executed on the processor to receive one or more user-defined campaign criteria from a user and prepare a media plan satisfying the user-defined campaign criteria, wherein the plan module is associated with a publisher database; and
a purchase module stored on the memory and executed on the processor to receive one or more inputs from the user and automatically create one or more media booking orders based on the inputs, wherein the inputs comprise one or more advertisements and one or more publishers selected by the user.

2. The system of claim 1, wherein the one or more publishers further comprising at least one user profile and/or personal web page.

3. The system of claim 1, wherein the one or more advertisements further comprising at least one offline advertisement, and the one or more publishers comprise at least one offline publisher.

4. The system of claim 1, wherein each publisher is associated with a unique launch code, such that advertising campaigns launched with a publisher are associated with the unique launch code of the publisher.

5. The system of claim 1, wherein each user is associated with a unique identification code, such that advertising campaigns launched by a user are associated with the unique identification code of the user.

6. The system of claim 1 further comprising a search module comprising:
a scraper module stored on the memory and executed on the processor to scrape at least one frame of each online web page in which an advertisement appears, thereby yielding at least one scraped frame;
an indexer module stored on the memory and executed on the processor to extract key words from the at least one scraped frame, wherein the scraper module and the indexer module populate an advertisement database with a plurality of advertisements, and index the advertisement database based on a predefined schema; and
a user interface module stored on the memory and executed on the processor to receive one or more user-defined search criteria from the user, and retrieve a result set of advertisements that satisfy the user-defined search criteria from the advertisement database.

7. The system of claim 6, wherein the predefined schema further comprising fields corresponding to at least one of identification of an advertisement, key words associated with the advertisement, the size of the advertisement, geography and demography where the advertisement is published, identification of one or more publishers who published the advertisement, information about click throughs and/or impressions, the file format, the file name, and the location where the advertisement is stored.

8. The system of claim 1 further comprising a create module stored on the memory and executed on the processor to create an advertisement based on one or more inputs from the user, wherein the create module allows the user to add a click to call feature to the advertisement.

9. The system of claim 1 further comprising a track module stored on the memory and executed on the processor to track the advertising campaign.

10. A method of launching an advertising campaign using a computer system, the method comprising the steps of:
receiving one or more user-defined campaign criteria from a user;
preparing a media plan satisfying the user-defined campaign criteria via a computer system comprising at least one memory, at least one processor, and at least one system bus;
receiving one or more inputs from the user, wherein the inputs comprise one or more advertisements and one or more publishers selected by the user; and
creating one or more media booking orders automatically, based on the inputs via the computer system.

11. The method of claim 10, wherein the user-defined campaign criteria further comprising at least one of: one or more publishers, budget for the advertising campaign, duration of advertisement, target geography, target audience, and key words.

12. The method of claim 10, wherein the one or more publishers further comprising at least one user profile and/or personal web page.

13. The method of claim 10 further comprising the step of associating each publisher with a unique launch code, such that advertising campaigns launched with a publisher are associated with the unique launch code of the publisher.

14. The method of claim 10 further comprising the step of associating each user with a unique identification code, such that advertising campaigns launched by a user are associated with the unique identification code of the user.

15. The method of claim 10 further comprising the steps of:
scraping at least one frame of each online web page in which an advertisement appears, thereby yielding at least one scraped frame;
extracting key words from the at least one scraped frame to populate an advertisement database with a plurality of advertisements;
indexing the advertisement database based on a predefined schema;
receiving one or more user-defined search criteria from the user; and
retrieving a result set of advertisements that satisfy the user-defined search criteria from the advertisement database.

16. The method of claim 15, wherein the predefined schema further comprising fields corresponding to at least one of identification of an advertisement, key words associated with the advertisement, the size of the advertisement, geography and demography where the advertisement is published, identification of one or more publishers who published the advertisement, information about click throughs and/or impressions, the file format, the file name, and the location where the advertisement is stored.

17. The method of claim 10 further comprising the step of creating an advertisement based on one or more inputs from the user.

18. The method of claim 10 further comprising the step of allowing the user to add a click to call feature to an advertisement.

19. The method of claim 10 further comprising the step of tracking the advertising campaign.
